(19) United States
(12) Patent Application Publication
(10) Pub. No.: US 2007/0165040 A1
(43) Pub. Date: Jul. 19, 2007

(54) DISPLAY APPARATUS CAPABLE OF PREVENTING FIRMWARE UPDATE FAILURE AND METHOD THEREOF

(76) Inventors: Ching-Tzong Wang, Kao-Hsiung City (TW); Szu-Ping Chen, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/621,119

(22) Filed: Jan. 9, 2007

(30) Foreign Application Priority Data
Jan. 13, 2006 (TW) 095101496

(51) Int. Cl. G06F 13/00

(52) U.S. Cl. 345/536

(57) ABSTRACT

The invention relates to a display apparatus and related method thereof capable of preventing firmware updating failure. The display apparatus includes a first memory block for storing a first firmware; a second memory block for storing a second firmware; and a micro controller unit coupled to the first memory block and the second memory block for accessing and executing the first firmware or the second firmware to control the operation of the display apparatus.

### BACKGROUND OF THE INVENTION

1. Field of the Invention

The invention relates to the field of display devices, and more particularly, to firmware update of display devices.

2. Description of the Prior Art

Display devices have become one of the most popular electronic devices in our daily lives, which broadly include personal computer monitors, adapting either CRT display technology or LCD display technology, and digital television using LCD display technology, PDP display technology, or other panel display technologies. Please refer to FIG. 1. FIG. 1 is a diagram of a conventional display apparatus 10. The display apparatus 10 comprises a microprocessor 12, a memory 14, a display controller 16, and a display panel 18. When the display apparatus 10 operates, the microprocessor 12 reads and executes a set of firmware program codes from the memory 12 to control the operation of the display apparatus 10, and then the display controller 16 processes received image data (including synchronization signals and R/G/B signals) to drive the display panel 18 for displaying a correct image.

Normally, the firmware that controls the display apparatus 10 will be recorded into the memory 14 before the display apparatus 10 is shipped to the market. The display apparatus 10, therefore, must be sent back to the manufacturer for updating its firmware when the user desires to resolve a malfunction situation of the display apparatus 10 or add new features to the display apparatus 10 by way of a firmware update. This imposes extra burden in terms of cost and time on both the consumers and the manufacturer.

### SUMMARY OF THE INVENTION

It is therefore one of the objectives of the present invention to provide a display apparatus suited for firmware update by end users and free from firmware update failure, and method thereof.

The present invention provides a display apparatus capable of preventing firmware updating failure. The apparatus comprises a first memory block, a second memory block, and a micro controller unit (MCU). The first memory block is utilized for storing a first firmware; the second memory block is utilized for storing a second firmware; and the micro controller unit (MCU) coupled to the first memory block and the second memory block for accessing and executing the first firmware or the second firmware to control the operation of the display apparatus.

The present invention provides a firmware updating method, applied to a display apparatus. The method comprises: reading a first firmware from a first memory block; using the display apparatus to display images according to the first firmware; reading a second firmware from a second memory block; using the display apparatus to display images according to the second firmware; and during the process of displaying images using the display apparatus according to the second firmware, updating the first firmware stored in the first memory block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional display apparatus.

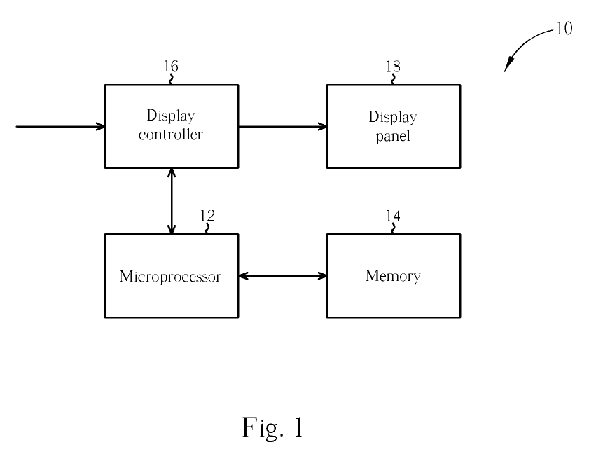

FIG. 2 is a diagram of a display apparatus which can avoid firmware update failure according to an embodiment of the present invention.

FIG. 3 is a flowchart of updating firmware of the display apparatus according to an embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

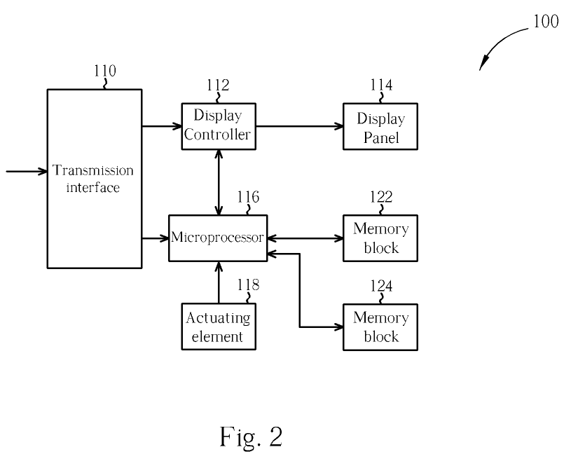

Please refer to FIG. 2. FIG. 2 is a diagram of a display apparatus 100 which can avoid firmware update failure according to an embodiment of the present invention. The display apparatus 100 comprises a transmission interface 110, a display controller 112, a display panel 114, a microprocessor 116, a plurality of memory blocks 122, 124, and an actuating element 118. In this embodiment, the display controller 112 can be an LCD controller that is installed in a computer monitor, or an LCD TV controller that is installed in an LCD TV or in a digital TV; however, these examples are not meant to serve as limitation of the present invention. The display controller 112 generally provides one or more of the image processing functionalities such as scaling, video decoding, and de-interlacing, etc., for a display system. The display panel 114 can be any one of the well-known display terminals such as an LCD panel, a PDP panel, even a non-panel-type terminal such as a cathode radiation tube (CRT), or any other image output element. The microprocessor 116 can be a well-known 8051 micro processing unit or any other device(s) with similar functionality. The memory blocks 122, 124 can be realized with a FLASH memory or other types of memory components. Please note that, according to choices of actual implementation, the above-mentioned display controller 122 and microprocessor 116, or the microprocessor 116 and memory blocks 122, 124, can be individual stand-alone devices, or can be integrally manufactured on the same substrate as an integrated circuit device.

In this embodiment of the present invention, a VGA (Video Graphic Array) connector is used as the transmission interface 110, where the VGA connector comprises a plurality of pins for transmitting synchronization signals and R/G/B signals, respectively, and also provides a Display Data Channel (DDC). Since the detailed specification of VGA connector is well known to those skilled in this art, further description is herein omitted for the sake of brevity. Please note that the VGA connector described herein serves merely as an example and is not meant to be a limitation of the present invention. Furthermore, in the present embodiment the above-mentioned actuating element 118 is implemented by a push button positioned on the monitor housing; however, those of ordinary skill in the art can understand that any known or new electronic components or mechanical components, which are suited for manually or automatically actuating mode switching, can be used to serve as said actuating element 118. Another example of the actuating element 118 can be found in a push button on a remote control that is designed to work with the display apparatus 100, and its actuation can be passed on to the microprocessor 116 in a remote manner such as infrared transmission.

The memory block 122 is used for storing a firmware FW1 that serves as a primary firmware, while the memory block 124 is used for storing another firmware FW2 that serves as a backup firmware. The actuating element 118 determines which firmware FW1 or FW2 is to be executed by the microprocessor 116 when the display apparatus 100 is operating. When the actuating element 118 is actuated so that the display apparatus 100 enters a first state, the microprocessor 116 reads the memory block 122 and executes firmware FW1. Similarly, when the actuating device 118 is actuated so that the display apparatus 100 enters a second state, the microprocessor 116 reads the memory block 124 and executes firmware FW2. Please note that memory blocks 122, 124 in this embodiment can be two different individual memories or two logically distinguishable memory blocks located in a single physical memory; however, this is not meant to be a limitation of the present invention.

As a default operation, the display apparatus 100 starts out at the first state and is thus controlled by firmware FW1. If the user needs to update firmware FW1 of the display apparatus 100, then the display apparatus 100 receives firmware data through the display data channel of the transmission interface 110, and the microprocessor 116 writes the received firmware data into the memory block 122 in an attempt to update firmware FW1. If any unexpected incidents (e.g., an abnormal power failure) occur during the firmware updating process that will result in an incomplete updating of firmware FW1 or an updating failure of firmware FW1, the firmware FW1 will not be able to work properly when the display apparatus 100 resumes normal operation. At this moment, the user can utilize the actuating element 118 (e.g., by pushing the button) to switch into the second state and then the display apparatus 100 reinitiates. Accordingly, the microprocessor 116 is able to execute firmware FW2 and the display apparatus 100 will again operate normally, this time under the control of firmware FW2. As a result, the user is allowed to update firmware FW1 again, and even repetitively updates firmware FW1 until firmware FW1 is successfully updated. After firmware FW1 is updated successfully, the user can then utilize the actuating element 118 (e.g., by pushing the button again) to switch back to the first state and restart the display apparatus 100 to check whether firmware FW1 can operate normally. If the firmware does not operate normally, then the user can re-select firmware FW2 as the controlling firmware and continue updating firmware FW1, or even use firmware FW2 to control the display apparatus 100 directly in spite of the failed attempt to update firmware FW1. Please note that in this embodiment, the display apparatus 100 only updates firmware FW1 through the transmission interface 110 but not firmware FW2, because firmware FW2 has passed quality tests before the display apparatus 100 is shipped to the market from the manufacturer, and is therefore guaranteed to function normally.

In the above-mentioned embodiment, the user manually switches the actuating device 118 to determine which firmware to be executed. In order to simplify the user operation, the present invention further discloses a second embodiment. The primary difference between the second and the first embodiments is that the microprocessor in the second embodiment is implemented by a microprocessor with a watch-dog function that will automatically execute firmware FW2 after the execution of firmware FW1 fails. Therefore, the actuating element 118 of the first embodiment can be further saved. Please note that, the microprocessor used in the present invention is not limited to those mentioned in above embodiments. In other words, other microprocessors with error detection functionality can also be used in the present invention.

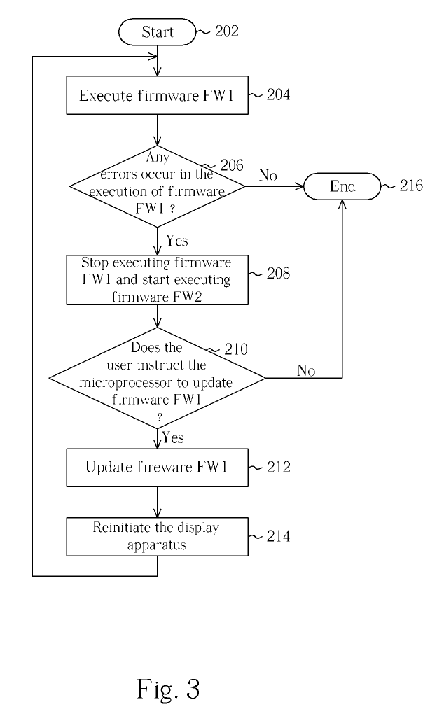

Please refer to FIG. 3. FIG. 3 is a flowchart of updating firmware FW1 of the display apparatus according to a second embodiment of the present invention. The updating process comprises the following steps:

Step 202: Start;

Step 204: Execute firmware FW1;

Step 206: Do any errors occur during the execution of firmware FW1? If yes, go to step 208; otherwise, go to step 216;

Step 208: Stop executing firmware FW1 and start executing firmware FW2;

Step 210: Does the user instruct the microprocessor to update firmware FW1? If yes, go to step 212; otherwise, go to step 216;

Step 212: Receive firmware data through a transmission interface to update firmware FW1;

Step 214: Reinitiate the display apparatus and execute step 204;

Step 216: Stop.

According to the second embodiment, the microprocessor automatically executes firmware FW1 after power on (step 204). If firmware FW1 contains errors or is corrupted/malfunction as a result of, for example, the previous firmware updating process, then problems can occur in the next execution of firmware FW1 after the display apparatus is powered on. At this time, the microprocessor with the watch-dog function will automatically stop execution of firmware FW1 and then execute firmware FW2 instead (step 208) to control the display apparatus. Furthermore, the microprocessor can display an error message on a screen to inform the user that firmware FW1 is damaged. In the mean time, if the user chooses to update firmware FW1 through the transmission interface, then the display apparatus will be reinitiated after the updating is completed (step 214). Therefore, the microprocessor is able to execute firmware FW1 (step 204) again to confirm whether the latest firmware updating is successful. If no error occurs, then the latest firmware updating is deemed successful; however, if errors occur, then the microprocessor will likewise automatically stop executing firmware FW1, and then execute firmware FW2 instead (step 208) to control the display apparatus.

The above-mentioned embodiments disclose that there are two sets of firmware data stored in the update failure-free display apparatus. When one firmware data is unable to work normally, the microprocessor in the display apparatus can execute the backup firmware to control the display apparatus. In this way, the user is allowed to download the newest firmware and there is no need to return the display apparatus to the manufacturer for firmware updating service.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus capable of preventing firmware updating failure, comprising:
a first memory block, for storing a first firmware;
a second memory block, for storing a second firmware; and
a micro controller unit (MCU), coupled to the first memory block and the second memory block, for accessing and executing the first firmware or the second firmware to control the operation of the display apparatus.

2. The display apparatus of claim 1, further comprising:
a transmission interface, coupled to the micro controller unit, for receiving a firmware data;
wherein the micro controller unit writes the firmware data into the first memory block to update the first firmware.

3. The display apparatus of claim 2, wherein the transmission interface comprises a display data channel (DDC).

4. The display apparatus of claim 2, wherein the micro controller unit does not write the firmware data into the second memory block to update the second firmware.

5. The display apparatus of claim 1, further comprising:
an actuating element, coupled to the micro controller unit;
wherein if the actuating element corresponds to a first state, the micro controller unit reads and executes the first firmware; and if the actuating element corresponds to a second state, the micro controller unit reads and executes the second firmware.

6. The display apparatus of claim 1, wherein if errors occur when the micro controller executes the first firmware, the micro controller unit stops executing the first firmware and then executes the second firmware instead.

7. The display apparatus of claim 1, wherein the first memory block and the second memory block are located in the same memory.

8. The display apparatus of claim 1, being a television.

9. A firmware updating method applied to a display apparatus, comprising:
reading a first firmware from a first memory block;
using the display apparatus to display images according to the first firmware;
reading a second firmware from a second memory block;
using the display apparatus to display images according to the second firmware; and
during the process of displaying images using the display apparatus according to the second firmware, updating the first firmware stored in the first memory block.

10. The firmware updating method of claim 9, further comprising:
setting an actuating element for switching the display apparatus from displaying images according to the first firmware to displaying images according to the second firmware.

11. The firmware updating method of claim 10, wherein the actuating element comprises a button of the display apparatus.

12. The firmware updating method of claim 10, wherein the actuating element comprises a watch-dog program of the display apparatus.

13. The firmware updating method of claim 9, further comprising:
reading the updated first firmware from the first memory block; and
utilizing the display apparatus to display images according to the updated first firmware.

14. The firmware updating method of claim 13, further comprising:
receiving an image data through a transmission interface.

15. The firmware updating method of claim 14, further comprising:
scaling the received image data.

16. The firmware updating method of claim 14, wherein the transmission interface comprises a VGA connector.

17. The firmware updating method of claim 13, further comprising:
receiving a firmware data utilized for updating the first firmware stored in the first memory block through a transmission interface.

18. The firmware updating method of claim 17, wherein the transmission interface comprises a display data channel.
